(19) United States
(12) Patent Application Publication
(10) Pub. No.: US 2016/0099531 A1
(43) Pub. Date: Apr. 7, 2016

(54) POWER OVER ETHERNET MIDSPAN INJECTION APPARATUS AND METHOD

(71) Applicant: Microsemi Corp. - Analog Mixed Signal Group, Ltd., Hod Hasharon (IL)

(72) Inventor: Yair DARSHAN, Petach Tikva (IL)

(21) Appl. No.: 14/864,079

(22) Filed: Sep. 24, 2015

Related U.S. Application Data
(60) Provisional application No. 62/060,030, filed on Oct. 6, 2014.

(51) Int. Cl. H01R 24/64; H01R 13/6461; H01R 25/00

(52) U.S. Cl. CPC H01R 24/64; H01R 25/00; H01R 13/6461

(57) ABSTRACT

A midspan injector constituted of: a circuit board; a power injection circuit; a plurality of electrical paths without crossover; a first jack comprising a plurality of pins; and a second jack comprising a plurality of pins, each in communication with a respective pin of the first jack via a respective electrical path, wherein each of the first jack and the second jack exhibits a receptacle with a protrusion of the receptacle extending from a side thereof, wherein the receptacle protrusion of the first jack extends along a first vector and the receptacle protrusion of the second jack extends along a second vector, the direction of the second vector opposing the direction of the first vector, and wherein the power injection circuit is arranged to: receive common mode DC power from a power source; and inject the received power into the plurality of electrical paths.

### TECHNICAL FIELD

The invention relates generally to the field of power over Ethernet (PoE), and in particular to a 10G midspan injection apparatus and method.

### BACKGROUND

Power over Ethernet (PoE), in accordance with both IEEE 802.3af-2003 and IEEE 802.3at-2009, each published by the Institute of Electrical and Electronics Engineers, Inc., New York, the entire contents of each of which is incorporated herein by reference, defines delivery of power over a set of 2 twisted wire pairs without appreciably disturbing data communication. The aforementioned standards particularly provide for a power sourcing equipment (PSE) arranged to provide power over the 2 twisted wire pairs and a powered device (PD) which is arranged to receive the power over the 2 twisted wire pairs.

10-gigabit (10G) Ethernet, also known as 10GBase-T, in accordance with IEEE 802.3-2012, published by the Institute of Electrical and Electronics Engineers, Inc., New York, the entire contents of which is incorporated herein by reference, defines Ethernet frame transmission at 10 gigabits per second. For 10G Ethernet, each data wire pair should be able to transmit data at frequencies of up to 500 MHz, preferably up to 600 MHz, such that 2.5 gigabits of information are encoded and compressed into the 500 MHz signal.

There are two methods of injecting power over Ethernet: Endspan; and Midspan. In Endspan injection, the PSE is provided at an Ethernet hub, or switch. The PSE provides power over the data wires connecting the Ethernet switch and the PD. In Midspan injection, the power is provided through a midspan injector arranged to inject the PSE supplied power into the data wires between the Ethernet hub or switch and the PD.

FIGS. 1A-1B illustrate various high level views of a PoE midspan injector 10 according to the prior art. In particular, FIG. 1A illustrates a high level top view of a schematic diagram of PoE midspan injector 10 and FIG. 1B illustrates a high level side view of the schematic diagram of PoE midspan injector 10, FIGS. 1A-1B being described together. PoE midspan injector 10 comprises: a circuit board 20 exhibiting a first face 25 and a second face 26, second face 26 opposing first face 25; a power sourcing equipment (PSE) 30; a power injection circuit 40; a first jack 50; a second jack 60; and a plurality of electrical paths 70. Circuit board 20 exhibits a plurality of borders 21, 22, 23 and 24. Border 21 is adjacent to borders 22 and 24 and opposes border 23. Border 22 is further adjacent to border 23 and opposes border 24. Each of first jack 50 and second jack 60 comprises 8 pins, sequentially numbered 1-8. Preferably, first jack 50 and second jack 60 are RJ-45 jacks. In one embodiment, circuit board 20 is a printed circuit board having printed thereon electrical paths 70. PSE 30 is illustrated as being positioned on circuit board 20, however this is not meant to be limiting in any way. Additionally, PoE midspan injector 10 is illustrated as comprising PSE 30, however this is not meant to be limiting in any way and PoE midspan injector 10 may be provided with a connection to an external PSE 30, without exceeding the scope.

Each of first and second jacks 50, 60 exhibit a generally rectangle shaped receptacle 80 with a plurality of borders 81, 82, 83 and 84. Border 81 is adjacent to borders 82 and 84 and opposes border 83. Border 82 is further adjacent to border 83 and opposes border 84. A protrusion 90 extends from an opening 100 in border 82 such that receptacle 80 is generally T shaped. The respective receptacle 80 extends into first jack 50 along a receptacle vector 95 and the respective receptacle 80 extends into second jack 60 along a receptacle vector 96, the direction of receptacle vector 96 the same as the direction of receptacle vector 95. First jack 50 and second jack 60 are each coupled to first face 25 of circuit board 20. Receptacle protrusion 90 of each jack 50, 60 extends along a respective protrusion vector 110, orthogonal to first face 25, receptacle protrusion 90 facing first face 25.

Each pin of first jack 50 is in electrical communication with an associated pin of second jack 60 via a respective electrical path 70. Particularly, pin 1 of first jack 50 is in electrical communication with pin 1 of second jack 60 via a respective electrical path 70. Pin 2 of first jack 50 is in electrical communication with pin 2 of second jack 60 via a respective electrical path 70. Pin 3 of first jack 50 is in electrical communication with pin 3 of second jack 60 via a respective electrical path 70. Pin 4 of first jack 50 is in electrical communication with pin 4 of second jack 60 via a respective electrical path 70. Pin 5 of first jack 50 is in electrical communication with pin 5 of second jack 60 via a respective electrical path 70. Pin 6 of first jack 50 is in electrical communication with pin 6 of second jack 60 via a respective electrical path 70. Pin 7 of first jack 50 is in electrical communication with pin 7 of second jack 60 via a respective electrical path 70. Pin 8 of first jack 50 is in electrical communication with pin 8 of second jack 60 via a respective electrical path 70.

In operation, a connector of an input Ethernet cable (not shown) is inserted into receptacle 80 of first jack 50 and a connector of an output Ethernet cable (not shown) is inserted into receptacle 80 of second jack 60. In one embodiment, the input and output Ethernet cables are Category 6 or Category 7 cables and the connector of each cable is an RJ-45 connector. The clip of each connector is disposed within receptacle protrusion 90 of the respective one of first jack 50 and second jack 60. Data is transferred from the input Ethernet cable to the output Ethernet cable, via first jack 50, electrical paths 70 and second jack 60. PSE 30 is arranged to output common mode DC power, optionally of 36-57 Volts, which is received by power injection circuit 40. Power injection circuit 40 is further arranged to inject the received common mode DC power into electrical paths 70. In one embodiment, the power injection is performed as described in U.S. Pat. No. 6,473,608 granted on Oct. 29, 2002 to Lehr et al., the entire contents of which are incorporated herein by reference. The injected DC power is output from PoE midspan injector 10 via second jack 60 and the output Ethernet cable.

As illustrated in FIG. 1A, since pins 2-8 of first jack 50 are located between pin 1 of first jack 50 and pin 1 of second jack 60, and pins 2-8 of second jack 60 are located between pin 1 of second jack 60 and border 23 of circuit board 20, the electrical path 70 connecting pins 1 of first jack 50 and second jack 60 crosses over the electrical paths 70 connecting pins 2-8 of first jack 50 and second jack 60. The same is true for each electrical path 70 connecting pins 2-8 of first jack 50 and second jack 60. Therefore, each electrical path 70 crosses over, or is crossed over by, each of the balance of the plurality of electrical paths 70. When data is being transferred through electrical paths 70 at a rate of 500 MHz, the crossover of electrical paths 70 causes crosstalk therebetween, thereby distorting and disrupting the data signals. Additionally, the need for vias, particularly unbalanced vias, adds to return loss.

There is thus a long felt need for a PoE midspan injector arranged to be used for 10G PoE, i.e. with Ethernet data transfer rates of at least 500 MHz.

### SUMMARY OF THE INVENTION

Accordingly, it is a principal object of the present invention to overcome the disadvantages of prior art PoE midspan injectors. This is provided in one embodiment by a PoE midspan injector comprising: a circuit board; a power injection circuit disposed on the circuit board; a plurality of electrical paths disposed on the circuit board; a first jack comprising a plurality of pins arranged to be coupled to the circuit board; and a second jack comprising a plurality of pins arranged to be coupled to the circuit board, each pin in electrical communication with a respective one of the plurality of pins of the first jack via a respective one of the plurality of electrical paths, wherein each of the first jack and the second jack exhibits a receptacle with a protrusion of the receptacle extending from a side of the receptacle, wherein the receptacle protrusion of the first jack extends along a first protrusion vector and the receptacle protrusion of the second jack extends along a second protrusion vector, the direction of the second protrusion vector opposing the direction of the first protrusion vector, and wherein the power injection circuit is arranged to:

receive common mode direct-current (DC) power from a DC power source; and inject the received common mode DC power into the plurality of electrical paths. In one embodiment, the receptacle of each of the first jack and the second jack is rectangular shaped, the protrusion extending from a side of the rectangle.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIGS. 1A-1B illustrate various views of a high level schematic diagram of a prior art PoE midspan injector;

FIGS. 2A-2B illustrate various views of a high level schematic diagram of a first embodiment of a PoE midspan injector, according to certain embodiments;

FIGS. 3A-3B illustrate various views of a high level schematic diagram of a second embodiment of a PoE midspan injector, according to certain embodiments; and

FIG. 4 illustrates a high level flow chart of a PoE midspan injection method.

### DETAILED DESCRIPTION OF THE PREFERRED EMBODIMENTS

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting. The term resistor as used herein refers to an element defined in an integrated circuit arranged to present resistance to a current flow there through.

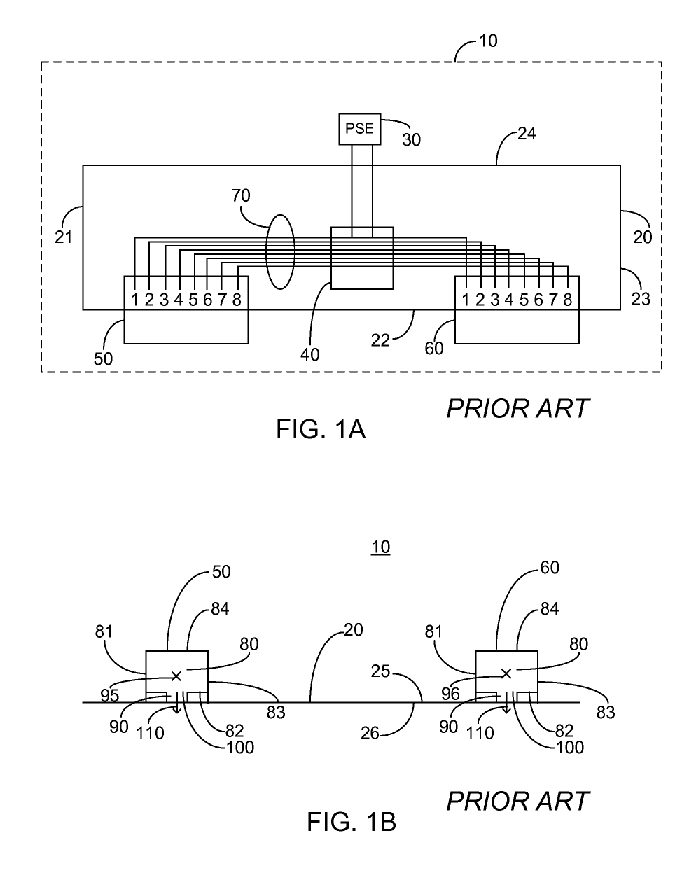

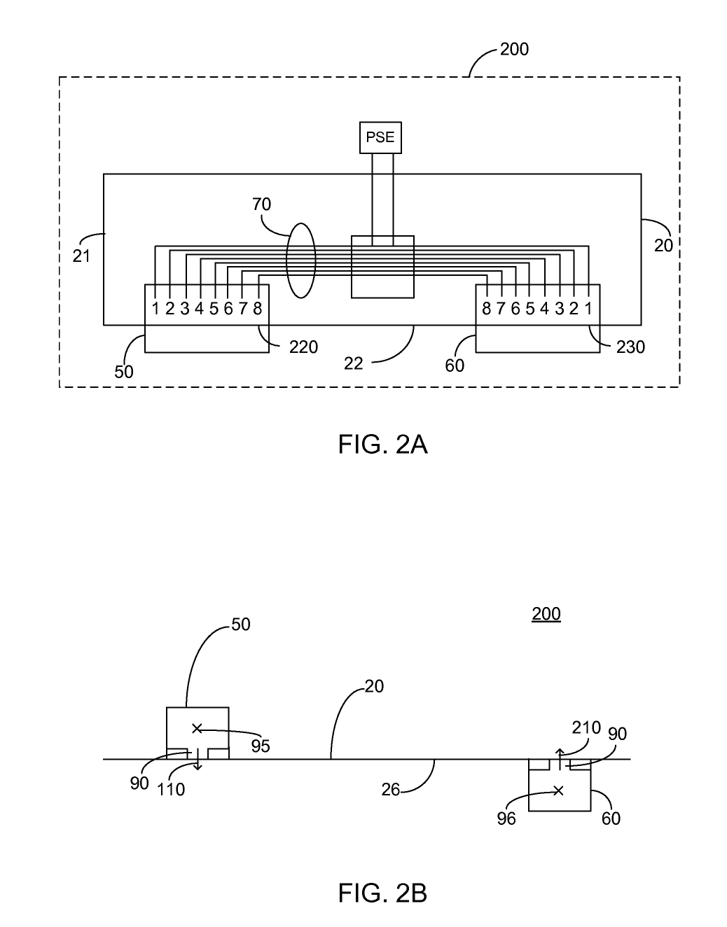

FIG. 2A illustrates a high level top view of a schematic diagram of a PoE midspan injector 200 and FIG. 2B illustrates a high level side view of the schematic diagram of PoE midspan injector 200, FIGS. 2A-2B being described together. PoE midspan injector 200 is in all respects similar to PoE midspan injector 10 of FIGS. 1A-1B, with the exception that second jack 60 is coupled to second face 26 of circuit board 20 and protrusion 90 of second jack 60 extends along a protrusion vector 210, the direction of protrusion vector 210 opposing the direction of protrusion vector 110 of protrusion 90 of first jack 50. First jack 50 is disposed on a first section 220 of border 22 of circuit board 20 and second jack 60 is disposed on a second section 230 of border 22 of circuit board, i.e. first jack 50 is spatially displaced from second jack 60 in a displacement direction orthogonal to the direction of first receptacle vector 95 and second receptacle vector 96. As illustrated in FIG. 2A, the pin arrangement of first jack 50 is the opposite of the pin arrangement of second jack 60. Particularly, pin 1 of first jack 50 is closer to border 21 of circuit board 20 than pin 8 thereof and pin 8 of second jack 60 is closer to border 21 than pin 1 thereof. As a result, electrical paths 70 connecting pins 1-8 of first jack 50 and second jack 60 do not cross over each other thereby reducing the amount of cross talk therebetween. Furthermore, depending on the layout and number of layers no vias may be required, and particularly no unbalanced vias may be required, thus improving return loss.

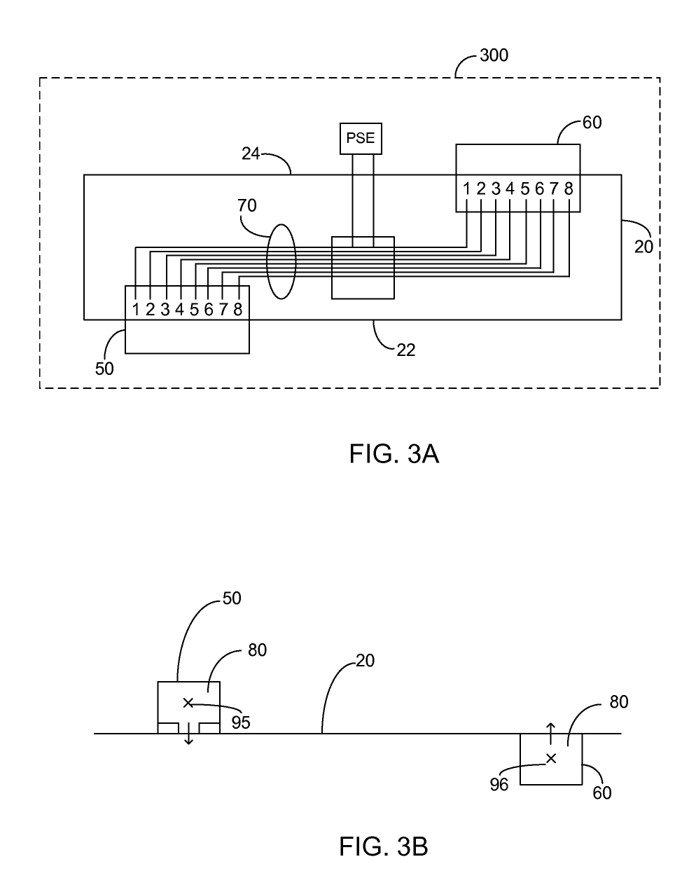

FIG. 3A illustrates a high level top view of a schematic diagram of a PoE midspan injector 300 and FIG. 3B illustrates a high level side view of the schematic diagram of PoE midspan injector 300, FIGS. 3A-3B being described together. PoE midspan injector 300 is in all respects similar to PoE midspan injector 200 of FIGS. 2A-2B, with the exception that first jack 50 is coupled to border 22 of circuit board 20 and second jack 60 is coupled to border 24 of circuit board 20. As a result, the direction of receptacle vector 95 of first jack 50 opposes the direction of receptacle vector 96 of second jack 60, i.e. receptacle 80 of first jack 50 is facing one direction and receptacle 80 of second jack 60 is facing the opposite direction and is therefore not shown in FIG. 3B. As a result, electrical paths 70 connecting pins 1-8 of first jack 50 and second jack 60 do not cross over each other thereby reducing the amount of cross talk therebetween. Furthermore, depending on the layout and number of layers no vias may be required, and particularly no unbalanced vias may be required, thus improving return loss.

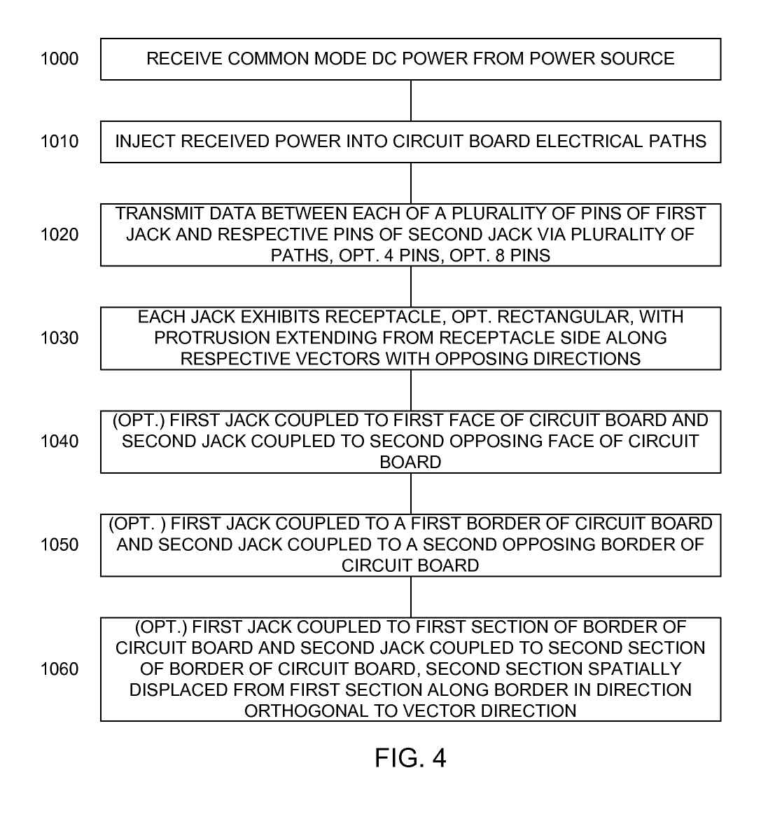

FIG. 4 illustrates a high level flow chart of a PoE midspan injection method, according to certain embodiments. In stage 1000, common mode DC power is received from a DC power source. In stage 1010, the received common mode DC power of stage 1000 is injected into a plurality of electrical paths disposed on a circuit board. Optionally, the circuit board is a printed circuit board and the plurality of electrical paths are printed thereon. The power injection is preferably performed with appropriate magnetic elements, as known to those skilled in the art at the time of the invention. In stage 1020, data is transmitted between each of a plurality of pins of a first jack and a respective one of a plurality of pins of a second jack, via a respective one of the plurality of electrical paths of stage 1010. Particularly, each pin of the first jack is in electrical communication with a respective pin of the second jack via a respective electrical path. Optionally, each of the first jack and the second jack comprise at least 4 pins, preferably 8 pins. Optionally, the first jack and the second jack are RJ-45 jacks. Preferably, both the first jack and the second jack are coupled to the circuit board of stage 1010.

In stage 1030, both the first jack and the second jack of stage 1020 exhibit a receptacle, with a protrusion of the receptacle extending from a side of the receptacle. Optionally, the receptacles of both the first jack and the second jack are generally rectangular shaped, the respective protrusion extending from a side of the rectangle. Particularly, each side of each receptacle is defined by a wall of the respective jack and the protrusion extends from an opening in one of the walls. The protrusion of the first jack extends along a first protrusion vector and the protrusion of the second jack extends along a second protrusion vector. The direction of the second protrusion vector opposes the direction of the first protrusion vector, i.e. the second jack is upside down in relation to the first jack. Advantageously, as described above in relation to FIGS. 2A-2B, in such a configuration the electrical paths of stages 1010-1020 do not cross over each other. As a result, there is a significant reduction in the cross talk of data between the electrical paths. Furthermore, depending on the layout and number of layers no vias may be required, and particularly no unbalanced vias may be required, thus improving return loss.

In optional stage 1040, the first jack of stages 1020-1030 is coupled to a first face of the circuit board of stage 1020 and the second jack of stages 1020-1030 is coupled to a second face of the circuit board, the second face of the circuit board opposing the first face thereof.

In optional stage 1050, the first jack of stages 1020-1030 is coupled to a first border of the circuit board of stage 1020 and the second jack of stages 1020-1030 is coupled to a second border of the circuit board, the second border of the circuit board opposing the first border thereof. In optional stage 1060, the first jack of stages 1020-1030 is coupled to a first section of a particular border of the circuit board of stage 1020 and the second jack of stages 1020-1030 is coupled to a second section of the particular border of the circuit board, the second section spatially displaced from the first section along the particular border in a displacement direction orthogonal to the direction of the first receptacle vector and the second receptacle vector.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

1. A power over Ethernet (PoE) midspan injector comprising:
a circuit board;
a power injection circuit disposed on said circuit board;
a plurality of electrical paths disposed on said circuit board;
a first jack comprising a plurality of pins arranged to be coupled to said circuit board; and
a second jack comprising a plurality of pins arranged to be coupled to said circuit board, each of said plurality of pins of said second jack in electrical communication with a respective one of said plurality of pins of said first jack via a respective one of said plurality of electrical paths,
wherein each of said first jack and said second jack exhibits a receptacle with a protrusion of said receptacle extending from a side of said receptacle,
wherein said receptacle protrusion of said first jack extends along a first protrusion vector and said receptacle protrusion of said second jack extends along a second protrusion vector, the direction of said second protrusion vector opposing the direction of said first protrusion vector, and
wherein said power injection circuit is arranged to:
receive common mode direct-current (DC) power from a DC power source; and
inject said received common mode DC power into said plurality of electrical paths.

2. The midspan injector of claim 1, wherein said receptacle of each of said first jack and said second jack is rectangular shaped, said protrusion extending from a side of the rectangle.

3. The midspan injector of claim 1, wherein said first jack is coupled to a first face of said circuit board and said second jack is coupled to a second face of said circuit board, said second face of said circuit board opposing said first face of said circuit board.

4. The midspan injector of claim 1, wherein said circuit board exhibits a plurality of borders, said first jack coupled to a first of said plurality of borders and said second jack coupled to a second of said plurality of borders, said second border opposing said first border.

5. The midspan injector of claim 1, wherein said circuit board exhibits a plurality of borders, said first jack coupled to a first section of a particular one of said plurality of borders of said circuit board and said second jack coupled to a second section of said particular border of said circuit board, said second section displaced from said first section along said particular border.

6. The midspan injector of claim 1, wherein said plurality of pins of each of said first jack and said second jack comprises at least 4 pins.

7. The midspan injector of claim 6, wherein said plurality of pins of each of said first jack and said second jack comprises 8 pins.

8. The midspan injector of claim 1, wherein none of said plurality of electrical paths cross over another of said plurality of electrical paths.

9. A power over Ethernet (PoE) midspan injection method, the method comprising:
receiving common mode direct-current (DC) power from a DC power source;
injecting said received common mode DC power into a plurality of electrical paths disposed on a circuit board; and
transmitting data between each of a plurality of pins of a first jack and a respective one of a plurality of pins of a second jack via a respective one of the plurality of electrical paths,
wherein each of the first jack and the second jack exhibits a receptacle with a protrusion of the receptacle extending from a side thereof, and
wherein the receptacle protrusion of the first jack extends along a first protrusion vector and the receptacle protrusion of the second jack extends along a second protrusion vector, the direction of the second protrusion vector opposing the direction of the first protrusion vector.

10. The method of claim 9, wherein the receptacle of each of the first jack and the second jack is rectangular shaped, the protrusion extending from a side of the rectangle.

11. The method of claim 9, wherein the first jack is coupled to a first face of the circuit board and the second jack is coupled to a second face of the circuit board, the second face of the circuit board opposing the first face of the circuit board.

12. The method of claim 9, wherein the first jack coupled to a first of a plurality of borders and the second jack coupled to a second of the plurality of borders, the second border opposing the first border.

13. The method of claim 9, wherein the first jack is coupled to a first section of a particular border of the circuit board and the second jack is coupled to a second section of the particular border of the circuit board, the second section displaced from the first section along the particular border.

14. The method of claim 9, wherein the plurality of pins of each of the first jack and the second jack comprises at least 4 pins.

15. The method of claim 14, wherein the plurality of pins of each of the first jack and the second jack comprises 8pins.

16. The method of claim 9, wherein none of said plurality of electrical paths cross over another of said plurality of electrical paths.

17. A power over Ethernet (PoE) midspan injector comprising:
a power injection circuit;
a plurality of electrical paths;
a first jack comprising a plurality of pins; and
a second jack comprising a plurality of pins, each of said plurality of pins of said second jack in electrical communication with a respective one of said plurality of pins of said first jack via a respective one of said plurality of electrical paths,
wherein each of said first jack and said second jack exhibits a receptacle with a protrusion of said receptacle extending from a first side of said receptacle,
wherein said receptacle protrusion of said first jack extends along a first protrusion vector and said receptacle protrusion of said second jack extends along a second protrusion vector, the direction of said second protrusion vector opposing the direction of said first protrusion vector, and
wherein said power injection circuit is arranged to:
receive common mode direct-current (DC) power from a DC power source; and
inject said received common mode DC power into said plurality of electrical paths.

18. The midspan injector of claim 17, wherein said receptacle of each of said first jack and said second jack is rectangular shaped, said protrusion extending from a side of the rectangle.

19. The midspan injector of claim 17, wherein said receptacle of said first jack extends into said first jack along a first receptacle vector and said receptacle of said second jack extends into said second jack along a second receptacle vector, the direction of said second receptacle vector opposing the direction of said first receptacle vector.

20. The midspan injector of claim 17, wherein said receptacle of said first jack extends into said first jack along a first receptacle vector and said receptacle of said second jack extends into said second jack along a second receptacle vector, the direction of said second receptacle vector the same as the direction of said first receptacle vector, said first jack spatially displaced from said second jack in a displacement direction orthogonal to the direction of said first receptacle vector and said second receptacle vector.

21. The midspan injector of claim 17, wherein said plurality of pins of each of said first jack and said second jack comprises at least 4 pins.

22. The midspan injector of claim 20, wherein said plurality of pins of each of said first jack and said second jack comprises 8 pins.

23. The midspan injector of claim 17, wherein none of said plurality of electrical paths cross over another of said plurality of electrical paths.
